(19) United States
(12) Patent Application Publication
(10) Pub. No.: US 2012/0137842 A1
(43) Pub. Date: Jun. 7, 2012

(54) FASTENER, DRIVER ENGAGING WITH THE FASTENER AND PUNCH PRODUCING THE FASTENER

(75) Inventors: XIAN-DONG GUO, Shenzhen City (CN); QING-YUN CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/179,782

(22) Filed: Jul. 11, 2011

(30) Foreign Application Priority Data
Dec. 6, 2010 (CN) 201010574438.2

(51) Int. Cl. B25B 23/00; F16B 23/00; F16B 35/00; B21J 13/02

(52) U.S. Cl. 81/460; 470/205; 411/403

(57) ABSTRACT

A fastener includes a connecting portion and a head portion connected with the connecting portion. The head portion defines an engaging hole and includes a plurality of protruding teeth separately formed on an inner peripheral wall of the engaging hole, respectively, toward a central axis of the engaging hole of the head portion, and a plurality of recesses are formed between every two adjacent protruding teeth, respectively. The head portion further includes a plurality of resisting projections separately formed on the inner peripheral wall of the engaging hole, toward the central axis of the engaging hole, and received within the corresponding plurality of the recesses of the head portion, respectively. The present disclosure further provides a driver engaging with the fastener and a punch producing the fastener.

### BACKGROUND

1. Technical Field

The present disclosure relates generally to fasteners, and particularly to a fastener, a driver engaging with the fastener, and a punch for making the fastener.

2. Description of Related Art

Fasteners are widely applied in many fields to securely connect two objects together. A commonly used fastener generally includes a head portion and a threaded connecting portion extending out from one end of the fastener head portion coaxially. The head portion defines a driving engaging hole in one end surface thereof away from the threaded connecting portion. However, the driving engaging hole of the existing fastener can be easily worn out.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings like reference numerals designate corresponding parts throughout the several views. Wherever possible, the same reference numerals are used throughout the drawings to refer to the same or like elements of an embodiment.

FIG. 1 is an isometric view of an embodiment of a fastener together with a driver, wherein, the driver includes a rod portion and a drive portion.

FIG. 2 is a cross-sectional view of the fastener and the driver of FIG. 1 taken in a plane parallel to the central axis of the fastener.

FIG. 3 is another cross-sectional view taken along a radial direction to the fastener (perpendicular to the plane in FIG. 2) of the fastener engaging with the driver.

FIG. 4 shows an end surface of the drive portion of the driver.

FIG. 5 is an isometric view showing a punch for producing or making the fastener of FIG. 1.

FIG. 6 is similar to FIG. 3, but viewed from another aspect.

### DETAILED DESCRIPTION

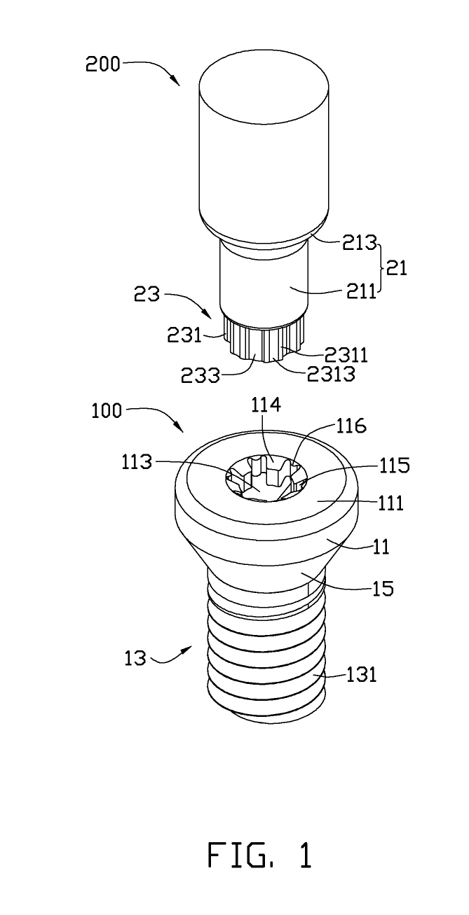

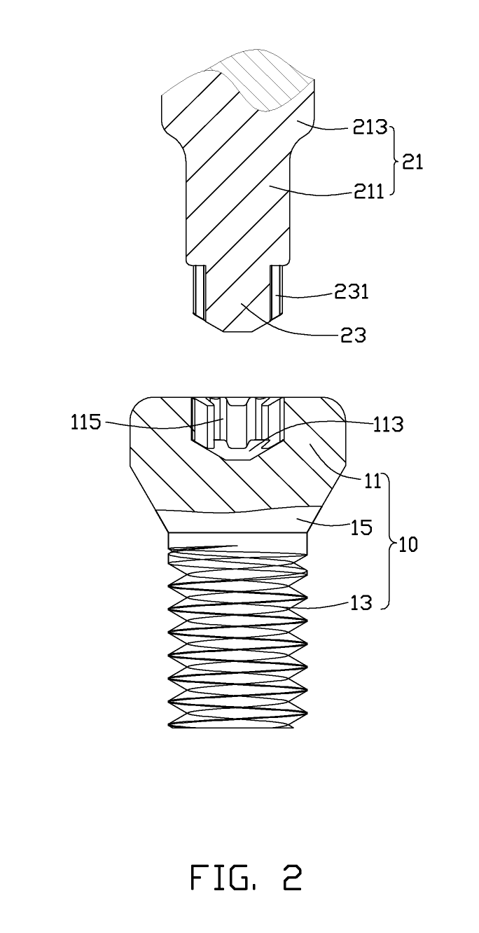

Referring to FIGS. 1 and 2, an embodiment of a fastener 100 includes a head portion 11 and a connecting portion 13 coaxially connected to the head portion 11. The head portion 11 includes an end surface 111 opposite to and positioned away from the connecting portion 13. A substantially circular-shaped engaging hole 113 is defined in the substantially central portion of the end surface 111 of the head portion 11. The connecting portion 13 is a substantially cylindrical threaded rod and defines a plurality of outside threads 131. A conical inclined surface 15 is formed between the head portion 11 and the connecting portion 13 as a joining portion.

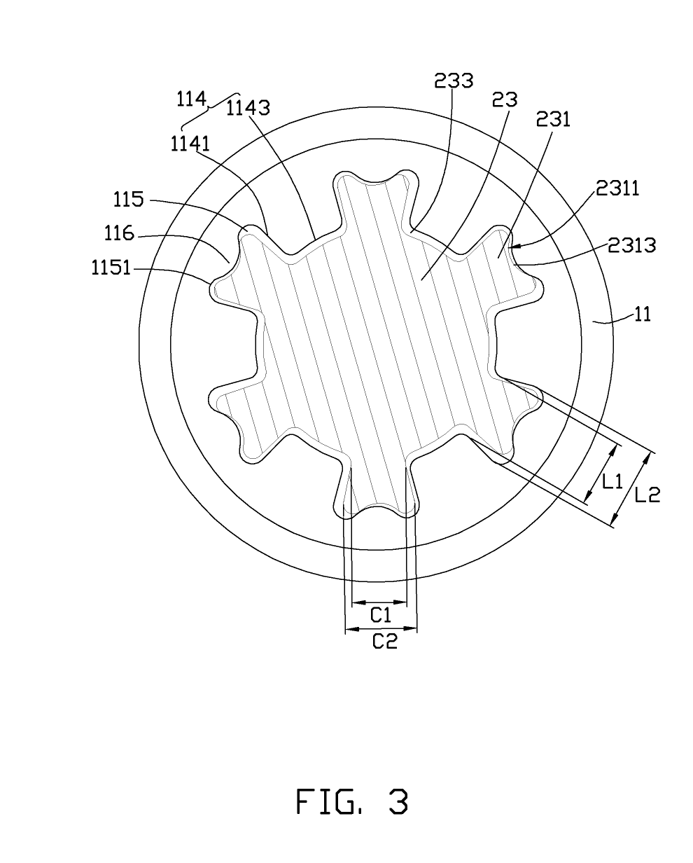

Also referring to FIG. 3, a plurality of protruding teeth 114 are separately formed on an inner peripheral wall of the engaging hole 113 of the head portion 11. All of the protruding teeth 114 separately protrude from the inner peripheral wall of the engaging hole 113 toward the central axis of the engaging hole 113 of the head portion 11, respectively. Correspondingly, a plurality of recesses 115 are formed between every two adjacent protruding teeth 114, respectively. A plurality of arc-shaped resisting projections 116 are separately formed on the inner peripheral wall of the engaging hole 113, toward the central axis of the engaging hole 113, and received within the corresponding plurality of recesses 115 of the head portion 11, respectively.

Each protruding tooth 114 is a substantially isosceles trapezoidal block, and includes two slanted side surfaces 1141 and a top surface 1143. Each slanted side surface 1141 is coplanar with a corresponding radial cross-section of the head portion 11 along the radial direction of engaging hole 113. Two ends of the top surface smoothly connect with the two slanted side surfaces 1141. Each recess 115 includes a bottom surface 1151 smoothly connecting with the adjacent two side surfaces 1141 of the two adjacent protruding teeth 114. A width L1 of the recess 115 adjacent to the top surface 1143 end is less than the width L2 of the bottom surface 1151 of the recess 115, along a circumferential direction of the head portion 11. Each resisting projection 116 projects from a substantially middle portion of the bottom surface 1151 toward the central axis of the head portion 11. In the illustrated embodiment, there are six protruding teeth 114 equally protruding from the inner peripheral wall of the engaging hole 113 toward the central axis of the head portion 11, respectively. Correspondingly, there are six recesses 115 formed between every two adjacent protruding teeth 114, respectively. Six arc-shaped resisting projections 116 are separately formed on the inner peripheral wall of the engaging hole 113, and received within the corresponding six recesses 115 of the head portion 11, respectively.

Further referring to FIGS. 1 through 3, an embodiment of a driver 200 includes a rod portion 21 and a drive portion 23 connected to the rod portion 21. The rod portion 21 includes a connecting end portion 211 connected to the drive portion 23 and a shaft shoulder 213 extending from the connecting end portion 211. An outer diameter of the connecting end portion 211 is slightly greater than or substantially the same as that of the drive portion 23, but less than the outer diameter of the shaft shoulder 213.

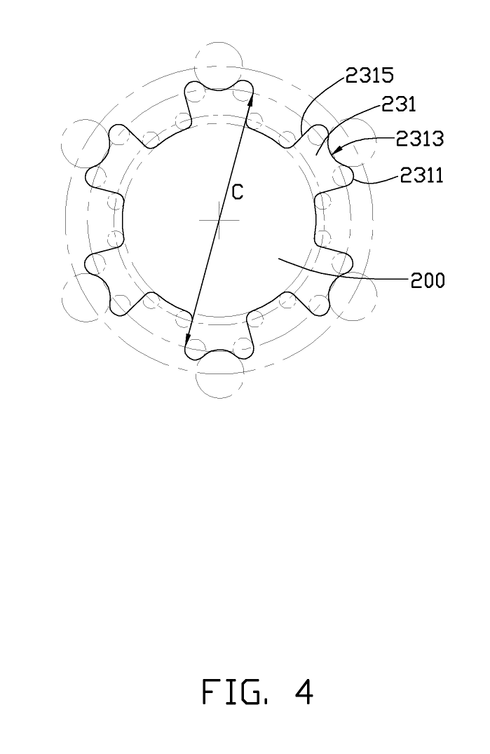

Also referring to FIG. 4, the drive portion 23 has a shape and dimension matching with that of the engaging hole 113 of the head portion 11 of the fastener 100. The drive portion 23 includes a plurality of drive teeth 231 separately protruding from an outer peripheral wall of the drive portion 23, respectively, and a plurality of engaging slots 233 correspondingly defined between every two adjacent drive teeth 231, respectively. Each drive tooth 231 includes an outer peripheral surface 2311 coaxial with the drive portion 23, and two resisting side surfaces 2315 smoothly connecting the outer peripheral surface 2311 and the adjacent engaging slot 233 together, respectively. A concave portion 2313 is recessed from the outer peripheral surface 2311 of each drive tooth 231. A width C1 of the drive tooth 231 adjacent to the bottom of the engaging slot 233 is less than the width C2 of the drive tooth 231 adjacent to the outer peripheral surface 2311, along a circumferencial direction of the drive portion 23. In the illustrated embodiment, the drive portion 23 of the driver 200 includes six drive teeth 231, and six engaging slots 233.

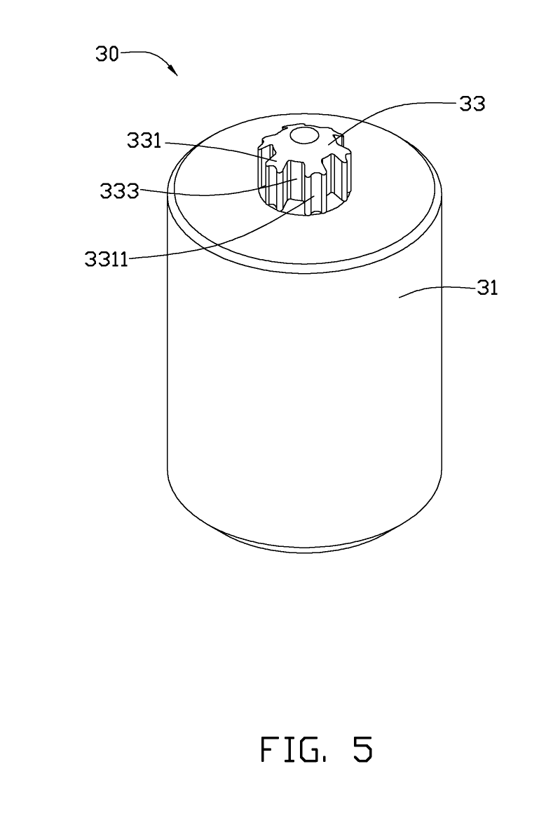

Referring to FIG. 5, an embodiment of a punch 30 for producing or making the fastener 100, includes a base body 31, and a punch head 33 formed on one end of the base body 31. The base body 31 is substantially cylindrical in the embodiment. The punch head 33 has a shape and dimension substantially the same as that of the corresponding engaging hole 113 of the head portion 11 of the fastener 100. The punch head 33 includes a plurality of gear-shaped cutting edges 331 separately formed on an outer periphery of the punch head 33, and a plurality of cutting slots 333 separately formed between every two adjacent cutting edges 331, respectively.

Each cutting edge 331 defines an arc-shaped cutting recession 3311 recessed from an outer peripheral surface thereof, for forming the resisting projection 116 of the fastener 100. In the illustrated embodiment, the total number of the cutting edges 331 and the total number of the cutting slots 333 are both six.

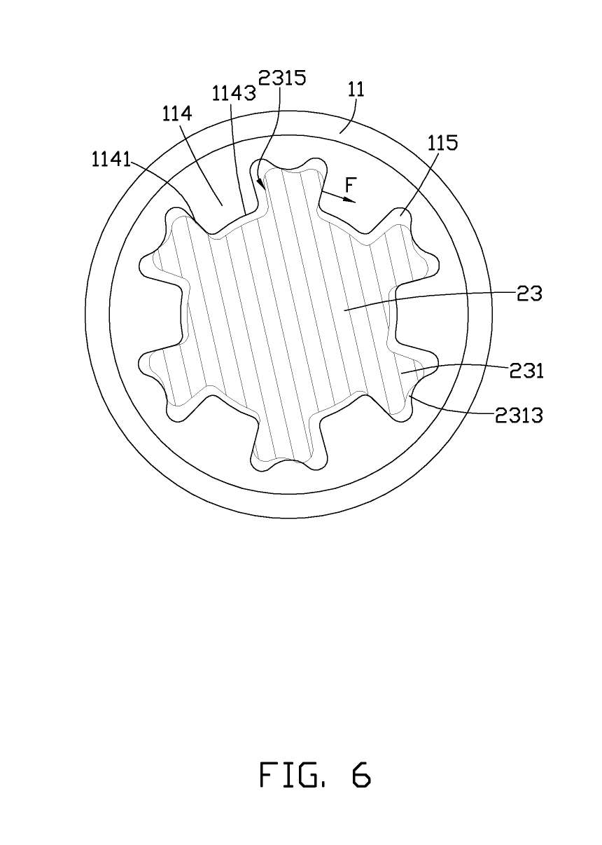

Also referring to FIGS. 1 through 6, when using the driver 200 to drive the fastener 100, the drive portion 23 of the driver 200 aligns with and is inserted into the engaging hole 113 of the head portion 11 of the fastener 100. The concave portions 2313 of the drive teeth 231 of the drive portion 23 engage with and resist against the resisting projections 116 of the fastener 100, respectively. An outer rotation force is applied to the driver 200 along the circumferencial direction of the driver 200 and the fastener 100, thereby urging the drive teeth 231 of the driver 200 to resist against the corresponding protruding teeth 114 of the fastener 100, respectively, along the circumferencial direction of the fastener 100, to drive the fastener 100 to rotate together with the driver 200.

The driver 200 has a simple structure, and is durable by means of the special structure of the drive teeth 231. In use, the concave portions 2313 of the drive teeth 231 engage with and resist against the corresponding resisting projections 116 of the fastener 100, respectively, during earlier usage period, which thereby prevents the drive teeth 231 of the driver 200 directly resisting against the protruding teeth 114 of the fastener 100. After the resisting projections 116 of the fastener 100 are worn out during usage, the drive teeth 231 of the driver 200 then further engage with and resist against the corresponding protruding side surfaces 1141 of the protruding teeth 114 of the fastener 100, for driving the fastener 100. Thus, the lifetime of the driver 200 is efficiently elongated.

It is to be understood, however, that even through numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener, comprising:
a connecting portion;
a head portion connected to the connecting portion, the head portion defining an engaging hole;
a plurality of protruding teeth separately formed on an inner peripheral wall of the engaging hole, respectively, protruding toward a central axis of the engaging hole of the head portion, thereby forming a plurality of recesses between every two adjacent protruding teeth, respectively; and
a plurality of resisting projections separately formed on the inner peripheral wall of the engaging hole, toward the central axis of the engaging hole, and received within the corresponding plurality of recesses of the head portion, respectively.

2. The fastener as claimed in claim 1, wherein the head portion comprises an end surface opposite to and positioned away from the connecting portion, the connecting portion is coaxially connecting with the head portion, and the engaging hole is defined in the substantially central portion of the end surface of the head portion.

3. The fastener as claimed in claim 1, wherein the connecting portion is a substantially cylindrical threaded rod and defines a plurality of outside threads.

4. The fastener as claimed in claim 2, wherein the fastener further comprises a conical inclined surface formed between the head portion and the connecting portion as a joining portion.

5. The fastener as claimed in claim 4, wherein each protruding tooth is a substantially isosceles trapezoidal block, and comprises two slanted side surfaces and a top surface facing toward the central axis of the engaging hole.

6. The fastener as claimed in claim 5, wherein each slanted side surface is coplanar with a corresponding radial cross section of the head portion along the radial direction of the engaging hole; two ends of the top surface smoothly connect with the two slanted side surfaces.

7. The fastener as claimed in claim 6, wherein each recess comprises a bottom surface smoothly connecting with the adjacent two side surfaces of the two adjacent protruding teeth.

8. The fastener as claimed in claim 7, wherein the width of the recess adjacent to the top surface end is less than the width of the bottom surface of the recess, along a circumferencial direction of the head portion; each resisting projection projects from a substantially middle portion of the bottom surface toward the central axis of the head portion.

9. The fastener as claimed in claim 1, wherein there are six protruding teeth equably protruding from the inner peripheral wall of the engaging hole toward the central axis of the head portion, respectively, six recesses are formed between every two adjacent protruding teeth, respectively, and six arc-shaped resisting projections separately formed on the inner peripheral wall of the engaging hole, and received within the corresponding six recesses of the head portion, respectively.

10. A driver for driving the fastener of claim 1, comprising:
a rod portion; and
a drive portion connecting with the rod portion, the drive portion having a shape and dimension matching with that of the engaging hole of the head portion of the fastener;
wherein the drive portion comprises a plurality of drive teeth separately protruding from an outer peripheral wall of the drive portion, respectively, and a plurality of engaging slots correspondingly formed between every two adjacent drive teeth, respectively.

11. The driver as claimed in claim 10, wherein each drive tooth comprises an outer peripheral surface being coaxial with the drive portion, and two resisting side surfaces smoothly connecting with the outer peripheral surface and the adjacent engaging slot, respectively.

12. The driver as claimed in claim 11, wherein each drive tooth further comprises a concave portion recessed from the outer peripheral surface of each drive tooth.

13. The driver as claimed in claim 11, wherein the rod portion comprising a connecting end portion and a shaft shoulder formed away from the connecting end portion.

14. The driver as claimed in claim 13, wherein the outer diameter of the connecting end portion is slightly greater than or substantially the same as that of the drive portion, but less than the outer diameter of the shaft shoulder.

15. A punch for producing the fastener of claim 1, comprising:
a base body; and
a punch head formed on one end of the base body, the punch head having a shape and dimension substantially the same as that of the corresponding engaging hole of the head portion of the fastener;
wherein the punch head comprises a plurality of gear-shaped cutting edges separately formed on an outer periphery of the punch head, and a plurality of cutting slots separately formed between every two adjacent cutting edges, respectively; each cutting edge defines a cutting recession recessed from an outer peripheral surface thereof, for forming the resisting projection of the fastener.
